(19) United States
(12) Patent Application Publication
(10) Pub. No.: US 2012/0309324 A1
(43) Pub. Date: Dec. 6, 2012

(54) MEASUREMENT METHOD AND APPARATUS

(76) Inventors: Wayne Rudd, Newcastle upon Tyne (GB); Allison Mason, Ponteland (GB); Laurie Linnett, Dirleton (GB)

(21) Appl. No.: 13/386,798

(22) PCT Filed: Jul. 22, 2010
(86) PCT No.: PCT/GB2010/001391

§ 371 Date: Jun. 11, 2012

(30) Foreign Application Priority Data
Jul. 24, 2009 (GB) 0912887.7

(51) Int. Cl. H04B 17/00

(52) U.S. Cl. 455/67.16

(57) ABSTRACT

Methods and apparatus for providing for determining the time of receipt of a received signal are described. In particular, there is described method and apparatus for receiving a signal, and using a phase characteristic, such as the received phase angle at which a received signal is initially sampled, together with the frequency of the received signal in order to determine a receive time error. The receive time error can then subsequently be used to determine the actual time of receipt of the received signal.

### TECHNICAL FIELD

The invention relates to the field of measurement methods and associated apparatus. In particular, but not exclusively, the invention relates to measurement of time of receipt of one or more signals, and/or the time of flight of one or more signals, and/or the distance travelled by one or more signals.

### BACKGROUND

In many industrial applications it is valuable to determine the precise time at which a signal is received. This may allow for the accurate determination of time of flight of that signal, and/or the distance travelled by that signal.

There are existing technologies that are used to determine the distance to one or more particular objects or targets. For example, RADAR, SONAR, Doppler systems, or the like, emit a signal and observe a received (reflected) signal in order to determine the distance to particular objects. To improve the sensitivity of such systems, the time at which a signal is received has to be determined accurately.

A common operation is to detect an exact time at which a pulsed signal arrives, or is received at a receiver. For discrete (digital) signals, a received signal is sampled at discrete intervals. These intervals are temporally spaced from one another. The size of the spacing is a function of the sampling frequency, or sampling rate. A problem arises when determining the exact time of arrival using these discrete samples. This is because the signal most likely arrives sometime between samples. In such cases, the best that can be achieved is to detect the arrival to within one sample.

To help overcome this, high sample rates are used to obtain finer estimates of the arrival time. However, as the sampling rates increase, the cost and complexity of the apparatus used, such as the electronics and the processing apparatus, increases.

### SUMMARY

According to a first aspect of the invention there is a method for providing for determining the time of receipt of a received signal, the method comprising:
using a phase characteristic associated with a received phase angle at which a received signal is initially sampled together with the frequency of the received signal to determine a receive time error, the receive time error representative of the time taken for the received signal to travel between a reference phase angle and the received phase angle so as to provide for determining the time of receipt of the received signal.

The phase characteristic may be associated with the reference phase angle and the received phase angle. The phase characteristic may be difference between the reference phase angle and the received phase angle. The phase characteristic may be the received phase angle (e.g. 5 degrees, 10 degrees, etc.). In such cases, the association, such as the difference, between the received phase angle and the reference phase angle may be determinable, determined, evaluated, approximated, etc.

The phase characteristic may be associated with (and/or derivable from) the amplitude of the received signal at the received phase angle (e.g. 10 dB, 15 dB, etc.). The amplitude may provide the received phase angle, or difference between reference phase angle and received phase angle. The phase characteristic may be the amplitude of the received signal at several samples, which may be sequential samples. These amplitudes may provide the received phase angle and/or the difference between the reference phase angle and the received phase angle.

The phase characteristic may be the ratio of the difference between the received phase angle and the reference phase angle, with the cycle of the received signal. The phase characteristic may be the ratio of the received phase angle with the cycle of the received signal (e.g. 5 degrees as a ratio of 360 degrees=0.013888).

The phase characteristic may be multiplied with the frequency of the received signal so as to provide the receive time error. The receive time error may relate to the time taken for a signal to travel from a reference phase angle to the received phase angle.

The reference phase angle may be associated with a particular characteristic of a transmitted signal. Such a transmitted signal may be for subsequent receipt as the received signal. The reference phase angle may be associated with the initial phase offset of a transmitted signal. The reference phase angle may be 0, 45, 90, 135, 180, 225, 270, 315, 360 degrees, or any angle therebetween, or may be roughly 0, 45, 90, 135, 180, 225, 270, 315, 360 degrees, or any angle therebetween. The reference phase angle may be 0, or 180 degrees.

The method may comprise using the two or more phase characteristics associated with the received phase angle in order to provide for determining the time of receipt of the signal. The two or more phase characteristics may be associated with two or more different samples. The two or more different samples may be temporally displaced. The two or more phase characteristics may be associated with two or more frequency components of the received signal. The two or more phase characteristics may be associated with the same or different reference phase angles.

The method may comprise comparing the two or more phase characteristics in order to provide the receive time error. This may allow for an accurate receive time error to be determined. For example, one or more phase characteristics may be predicted based on a previously used/observed phase characteristic. The predicted phase characteristic may be based on one or more of: the frequency of the received signal; the sampling frequency of the received signal; and the phase characteristic of one or more previous samples. Where an actual phase characteristic at a particular sample and the predicted phase characteristic at that sample differ, such as significantly differ (e.g. beyond a threshold), then the one, some or all of those phase characteristics may be disregarded for determining the receive time error.

The two or more phase characteristics may be one or more of: compared, predicted, averaged, approximated, or the like, in order to provide a receive time error (e.g. an average receive time error, for example, an average receive time error based on an average phase characteristic).

The two or more phase characteristics may provide two or more receive time errors. The two or more receive time errors may be one or more of: compared, predicted, averaged, approximated, or the like, in order to provide for determining the time of receipt of a signal (e.g. some or all of the receive time errors may be averaged in order to provide an averaged received error time). For example, the two or more receive time errors may be predicted, compared, averaged, approximated, or the like, based on the frequency of the received signal and/or the sampling frequency

The method may comprise comparing the phase characteristic(s) and/or receive time error(s) associated with samples occurring at the same, or similar, phase angles in one or more subsequent cycles of the received signal. For example, if the receive phase angle is 5 degrees, the method may comprise comparing the phase characteristic(s) and/or receive time error(s) associated with that observed/determined at 5 degrees in a subsequent cycle of the received signal (i.e. comparing the phase characteristics at 5 degrees, 365 degrees, 725 degrees).

The method may comprise comparing two or more (e.g. all) phase characteristics and/or receive time errors associated with one cycle of the received signal, with the phase characteristics and/or receive time errors of one or more subsequent cycles of the received signal. Such an arrangement may allow for the receive time error to be averaged, or the like.

The method may comprise sampling the received signal. The method may comprise sampling the received signal at a sampling frequency corresponding to the frequency of the signal. The method may comprise sampling the received signal at a sampling frequency corresponding to the frequency of the signal so as to provide an integer number of samples per cycle. The integer number of samples may be considered to be the sample integer. The sample integer may allow the phase characteristics/receive error time of the signal to be readily compared at subsequent samples, and/or for the received signal to be readily processed, such as proceeded using Discrete Fourier Transforms (DFT), which may be to a particular sample bin.

The method may comprise providing a signal amplitude at two or more samples of the received signal. The signal amplitude may be observed by discrete frequency response (e.g. using DFT analysis). The method may comprise using the phase characteristic associated with a particular sample associated with a particular amplitude, for example, the largest signal amplitude (e.g. in a sample bin), to provide the receive time error.

The signal amplitude may be provided for two or more sets of samples. Each set of samples may comprise a number of samples corresponding to the sample integer (e.g. each sample set may comprise the same number of samples as the sample integer, such as eight samples, or the like). The two or more sets of sample may have one or more overlapping sample. The two or more sets of sample may differ by only a single sample. The method may comprise providing a sliding DFT effect. The method may comprise using the phase characteristics associated with a particular sample set associated with a particular amplitude, for example, the largest signal amplitude (e.g. in a sample bin), to provide the receive time error.

The method may comprise receiving the received signal (e.g. using a transducer; by wireless/wired/optical communication, or the like, which may have been received at a different location).

The receive time error may be used with a receive time of the signal in order to provide for determining the time of receipt of the signal. The receive time may be a further time, or secondary time, such as an approximated, guessed, estimated determined time, or the like.

The receive time may relate to the time at which the received signal is initially sampled. The receive time may be the time of the initial sample of the received signal. The receive time may be associated with the time between a transmitted signal being transmitted for subsequent receipt as the received signal, and the time of the initial sample of the received signal. The receive time may be the time taken between a transmitted signal being transmitted for subsequent receipt as the received signal, and the time of the initial sample of the received signal.

The receive time may be provided by using a sample number of the initial sample, and the sampling frequency used to sample the received signal. The sample number may be the cumulative number of samples taken between a reference time and the initial sample. The sample number may be the cumulative number of samples taken between transmitting a transmitted signal and receiving the received signal.

The method may comprise transmitting a signal (e.g. for subsequent receipt as a received signal). For example, transmitting a signal by using a transducer or the like. The frequency of the transmitted signal may be selected based on the sampling frequency. The phase offset of the transmitted signal may be provided depending upon the desired reference phase angle.

The method may comprise determining the time of receipt of the signal. For example, the time of receipt may be determined to be the received time minus the receive time error. Determining the time of receipt may use the receive time plus the receive time error.

The method may comprise using the time of receipt to determine time of flight of the received signal. The time of receipt may be the time of flight of the received signal. The method may comprise using the speed of the signal and time of receipt in order to determine the distance travelled by the received signal, which may be a reflected distance.

The speed of the signal may be approximated, estimated, guessed, measured, or the like. The method may further comprise determining the speed of the signal (e.g. in order to provide for determining the distance travelled).

The received signal may comprise an acoustic signal, electromagnetic signal, etc. The method may be for use in determining time of receipt of a signal used in a flowmeter. For example, the method may be used in the oil and gas industry.

According to a second aspect of the invention there is apparatus for providing for determining the time of receipt of a received signal, the apparatus configured to use a phase characteristic associated with a received phase angle at which a received signal is initially sampled together with the frequency of the received signal to determine a receive time error, the receive time error representative of the time taken for the received signal to travel between a reference phase angle and the received phase angle, the apparatus configured to provide for determining the time of receipt of the received signal.

The apparatus may be configured with one or more receivers and/or transmitters in order to transmit/receive a signal. The apparatus may be configured to sample a received signal, for example, by using an analogue to digital converter. The apparatus may be configured for use with signals comprising acoustic, electromagnetic signals, or the like.

According to a third aspect of the invention there is provided a measurement device comprising the apparatus of the second aspect.

The measurement device may be configured as an oil and gas measurement device, for example, a measurement device for the oil and gas industry (e.g. a flow meter).

According to a fourth aspect of the invention there is a method for providing for determining the time of flight of a received signal, the method comprising:
using a phase characteristic associated with a received phase angle at which a received signal is initially sampled together with the frequency of the received signal to determine a receive time error, the receive time error representative of the time taken for the received signal to travel between a reference phase angle and the received phase angle so as to provide for determining the time of flight of the received signal.

According to a fifth aspect of the invention there is a method for providing for determining the distance to one or more targets using a received signal, the method comprising:
using a phase characteristic associated with a received phase angle at which a received signal is initially sampled together with the frequency of the received signal to determine a receive time error, the receive time error representative of the time taken for the received signal to travel between a reference phase angle and the received phase angle so as to provide for determining the distance to one or more targets using the received signal.

According to a sixth aspect of the invention there is provided a method for providing for determining the time of receipt of a signal, the method comprising:
using a phase characteristic associated with a sampled received signal at a particular sample time with the frequency of the received signal, in order to provide for determining the time of receipt of the signal.

According to a seventh aspect of the invention, there is provided a method for determining the time of receipt of a signal, comprising:
sampling a signal being received at a receiver;
determining a received phase angle of the signal, the received phase angle being the phase angle of the signal at an initial sample;
determining the phase difference between the received phase angle and a reference angle; and
using the phase difference together with the frequency of the signal to determine a receive time error, the receive time error usable to determine the time of receipt of the signal at the receiver.

According to an eighth aspect of the invention there is provided a computer program, stored, or storable, on a computer readily medium, the computer program configured to provide the method of any of the first, fourth, fifth, sixth and/or seventh aspects of the invention.

The present invention includes one or more corresponding aspects, embodiments or features in isolation or in various combinations whether or not specifically stated (including claimed) in that combination or in isolation. For example, it will be appreciated that any of the features of the first aspect may be used with the second to seventh aspects.

It will be appreciated that one or more embodiments/aspects may be useful when determining the time of receipt of a signal, and/or the time of flight, and/or the distance to one or more targets.

The above summary is intended to be merely exemplary and non-limiting.

### BRIEF DESCRIPTION OF THE FIGURES

A description is now given, by way of example only, with reference to the accompanying drawings, in which:

FIG. 1 shows a single cycle of a signal being transmitted and received;

FIGS. 2a and 2b show a signal being sampled at sample times, and FIG. 2c shows a similar signal having two frequency components;

FIG. 3 shows a further example of a signal being sampled at sample times;

FIG. 4a shows an example of a signal and FIG. 4b shows a further example of a signal;

FIG. 6 shows a the amplitude obtained of a sliding DFT; and

FIG. 7 shows a particular portion of FIG. 6.

### DETAILED DESCRIPTION OF THE FIGURES

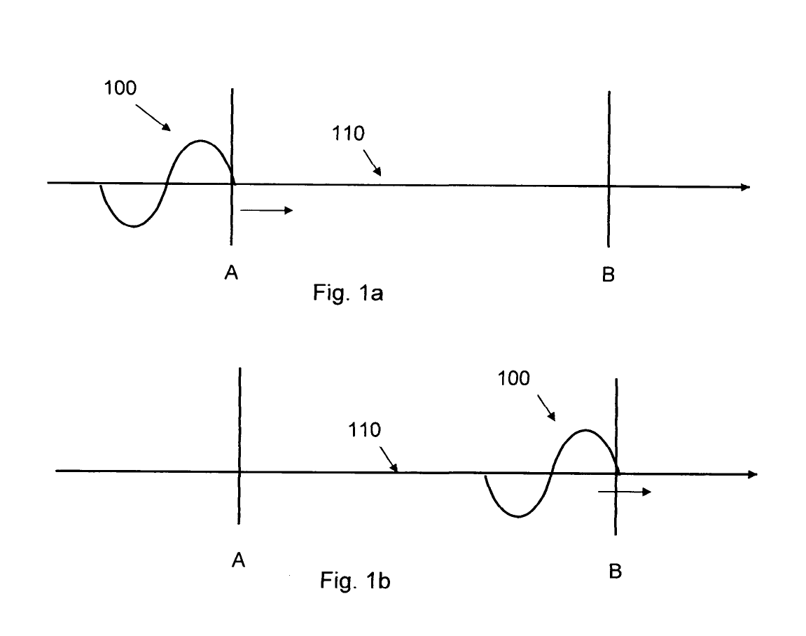

FIG. 1 shows an exemplary waveform of a signal 100, which is being transmitted from point A along a transmission path 110 and is being received at point B. In this example, the signal 100 is an acoustic signal having an initial phase offset of zero. That is to say that the phase at which the signal 100 is initially transmitted at point A is zero.

By knowing (or guessing, estimating, etc.) the time at which the signal 100 is transmitted from A and the time at which the signal 100 is received at B, the time of flight of the signal 100 along the transmission path 110 can be determined. By determining this time of flight, other measurements can be derived, such as the distance from point A to point B (e.g. by providing the speed of the signal 100 along the transmission path 110).

The time of the receipt of the signal 100 can be determined by sampling the received signal 100 (or lack of the received signal 100) at point B with one or more samples. The time between successive samples is determined by the sampling frequency. With a coarse sampling frequency the sample at which the signal 100 is initially observed may not coincide with the time at which the signal 100 actually arrives at point B.

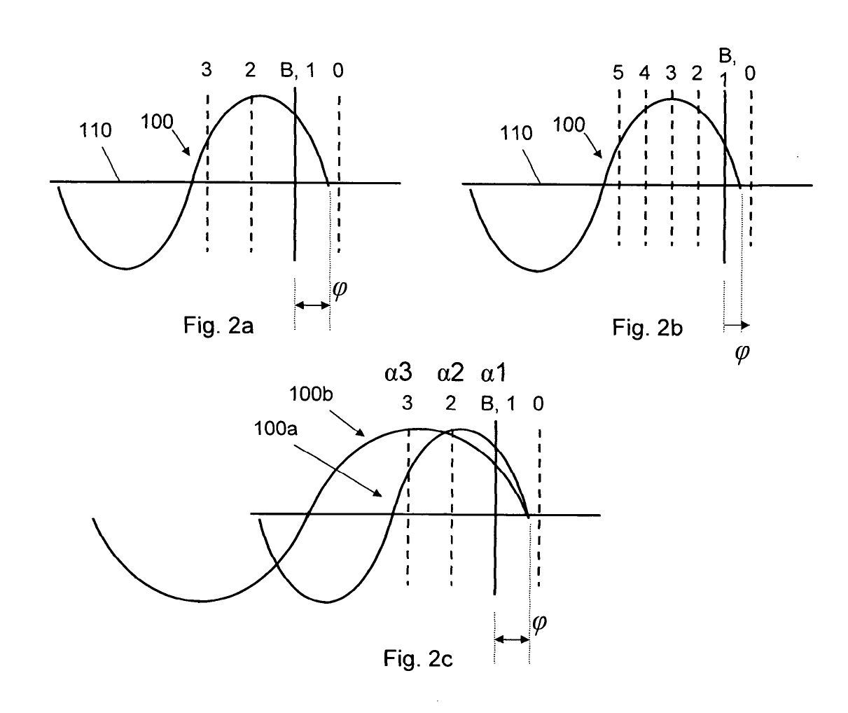

Consider the example shown in FIG. 2a. Here, the received signal 100 has been sampled at regular sample intervals of 0, 1, 2, 3 . . . . The signal 100 has arrived at point B between the sample of 0 and 1. As a result, the presence of the received signal 100 is initially identified at the sample of 1, at which time the received signal 100 has passed point B by the angle φ. The angle φ may be considered to be the difference between a reference phase angle and the phase angle of the received signal at the initial sample of 1 (such a phase angle being considered to be the received phase angle). In this embodiment, the reference phase angle is zero because that was the initial phase offset of the transmitted signal. However, in further embodiments the reference phase angle may be a further angle.

The angle φ relates to the amount of the received signal 100 that has passed point B before the initial sample observes that the signal 100 has been received at B. Because the signal 100 is travelling at a particular speed along the transmission path 110, this angle φ can be considered to be representative of a particular amount of time that has elapsed between the beginning of the signal 100 being received at point B and the signal being observed at point B.

This time may be considered to be the receive time error. That is to say, the (actual) time of receipt of the received signal 100 reaching point B is the time at which the received signal 100 was first observed (e.g. so-called receive time, which occurs at initial sample 1) minus the receive time error.

In order to improve the accuracy of determining the time of receipt of the signal 100 (and the time of flight, etc.), one solution is to reduce time interval between sample (i.e. increase the sampling frequency). FIG. 2b exemplifies this. Here, the angle φ (or the receive time error) is less than that of FIG. 2a, and thus the accuracy when determining the time of receipt of a signal is improved. Of course, to improve upon the example shown in FIG. 2b, the time interval between samples can be reduced further. However, providing smaller sample intervals becomes costly in terms of electronics and processing required.

The invention permits the time of receipt of the signal 100 to be determined more accurately, without increasing the sampling frequency. Consider, by way of an example, that the received signal 100 shown in FIG. 2b has a frequency of 0.1 Hz. Consider also that the sampling frequency used is 0.8 Hz. This satisfies Nyquist criteria.

At the initial sample (for example, sample 1 in FIG. 2b), the received signal is observed and a phase characteristic of the received signal can be determined (e.g. the amplitude, and/or the received phase angle). At that initial sample, the receive time of the signal 100 is noted. The receive time is considered to be an approximated time of receipt, which for this example can be considered to be 10 seconds.

Here, the phase characteristic is the received phase angle of the received signal at the initial sample. However, in alternative embodiments, the phase characteristic may be a further characteristic that provides for the received phase angle to be determined (e.g. the amplitude of the received signal 100 at that particular sample, or the amplitude of the received signal 100 at one or more associated samples). Here, the phase characteristic is 5.76 degrees (i.e. φ=5.76 degrees).

From this value, the fraction (or ratio) of a complete cycle can be determined. This can be considered to be 5.76/360=0.016. Because the frequency of the received signal 100 is known, it is possible to determine the receive time error as being 0.016×(1/signal-frequency)=0.016×(1/0.1)=0.16 seconds. That is to say that the time of receipt of the signal can be considered to be the receive time at sample 1 minus the receive time error (i.e. 10 seconds−0.16 seconds=9.84 seconds).

In such an arrangement, a more accurate time of receipt of the received signal 100 can be determined (i.e. without needing to increase the sampling frequency).

Consider also that because the sampling frequency is known (which in this example is 0.8 Hz), the phase characteristic at subsequent samples might be predicted, and/or compared. Such an arrangement allows for noise to be removed, and/or for spurious results to be disregarded. In the example above, where the sampling frequency is 0.8 Hz and the frequency of the signal is 0.1 Hz, it can be determined that the phase angle at each subsequent sample will be (or should be) displaced from the phase angle of a previous sample by 45 degrees. Considering the example above, the phase angle at subsequent samples after the initial sample should be 50.76, 95.76, 140.76 degrees, etc. The phase angle at one, some, or all these subsequent samples may be used in order to determine the receive phase angle. That is to say consider that the subsequent phase angle is determined to be 51.76, rather than 50.76. In some embodiments, the received phase angle may be disregarded for determining a receive time error. In further embodiments, an approximated received phase angle may be provided as based on the received phase angle and one or more subsequent phase angles (e.g. by averaging the adjusted phase angles).

In some embodiments, the phase angle (e.g. the received phase angle, or subsequent phase angles) might be compared, or averaged with the angle from corresponding samples. The phase angle of the initial sample may be averaged with the phase angle of one or more subsequent samples, where the subsequent samples are at the same, or similar, part of the cycle (e.g. 5 degrees, 366 degrees, 723 degrees provides a received phase angle of 4.666). In further embodiments, the phase angle may be average across some or all of the samples in a cycle. For example the average of the determined received phase angle in cycle 1=5 degrees, the average of the determined received phase angle in cycle 2=6 degrees, the average of the determined received phase angle in cycle 3=5 degrees, therefore the average received phase angle=5.3 degrees).

It will readily be appreciated to the skilled reader that the same analysis may be applied when looking at the phase difference between two or more frequency components 100a, 100b of a received signal 100, which may be received at the same, or a similar time. FIG. 2c shows an exemplary configuration of such a received signal 100 comprising two frequency components 100a, 100b being received at point B. Here, each frequency component 100a, 100b has a different known frequency. However, for simplicity, each have the same initial phase offset.

The received phase angle for each frequency component 100a, 100b may be determined. In one example, this may be expressed as the difference in phase angle, α, between the two frequency components 100a, 100b. Because the two frequencies are known, and because the sampling frequency is known, each subsequent difference in phase angle, α1, α2, α3, etc. can be determined, averaged, etc. in a similar manner to that described above. It will readily be appreciated that the amplitude and/or phase angles of the frequency components 100a, 100b may be used in this manner.

In such cases, the variance of the phase characteristics of one frequency component 100a of a received signal 100 with the phase characteristics of another frequency component 100b of a received signal 100 can be compared in samples taken at the same, or similar, time. In addition, the variance of the phase characteristics of one frequency component 100a of a received signal with the received phase characteristics of another frequency component 100b of the received signal can be compared over subsequent samples so as to determine that the correct variance has been identified.

That is to say that with the sampling frequency being known, and the frequency of one or more frequency components being known, then the anticipated received phase characterises (and/or difference in received phase characteristics) can be predicted. Subsequent samples can be compared to ensure that the correct difference in phase characteristic is observed. In some configurations, the difference in phase characteristic (e.g. phase angles) between a first frequency component 100a and a second frequency component 100b should vary linearly, or roughly linearly, when sampled over a period of time. The same analysis is applicable to a received signal comprising more than two frequency components 100a, 100b.

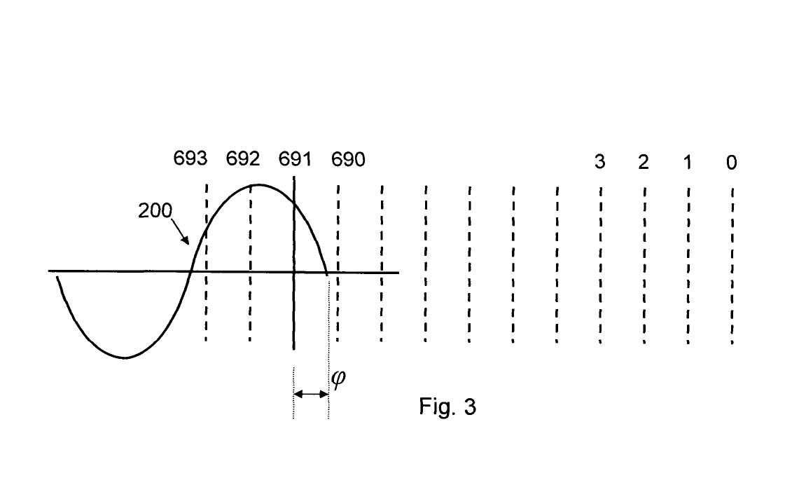

It will readily be appreciated that in relation to FIG. 2, samples are taken after, or around about the time, it has been determined that the received signal 100 has arrived. FIG. 3 shows a further received signal 200, similar to that described in relation to FIG. 2a. In this embodiment, samples are taken from a particular time, which here corresponds to the time at which the received signal is first transmitted.

As is shown in FIG. 3, from sample 0 to 689, no signal 200 is observed. At sample 690 the signal 200 has arrived (but has overshot by the angle φ before it is observed). In this case, the receive time (i.e. that time at which the signal is received at sample time 690) can be determined by taking the time of the cumulative sample. For example, consider the example above (i.e. sampling frequency of 0.8 Hz), it can shown that:

$$t = \frac{N}{{f}_{s}} - \frac{φ}{360 * f} \qquad ( 1 )$$

where t is the time of receipt of the signal, N is the number of sample times until the signal is observed (e.g. 690), fₛ is the sampling frequency (e.g. 0.8 Hz), φ is the overshoot angle in degrees, and f is the frequency of the signal.

While in the above embodiments, the reference phase angle is zero because the transmitted signal has a zero phase offset, it will be appreciated that in some embodiments, the received signal may be received in which it is apparent that the signal has taken some time to “build up” (and/or “build down”) when transmitted.

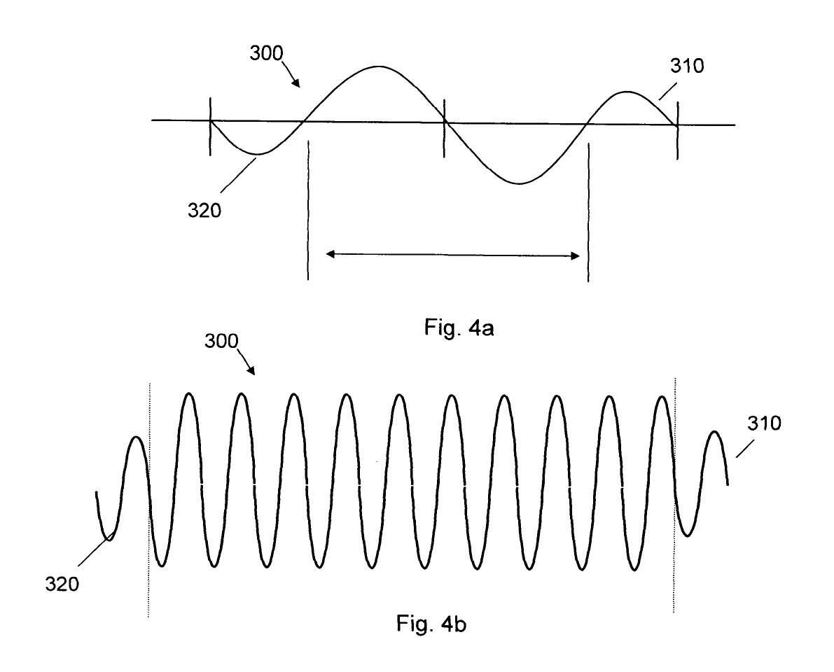

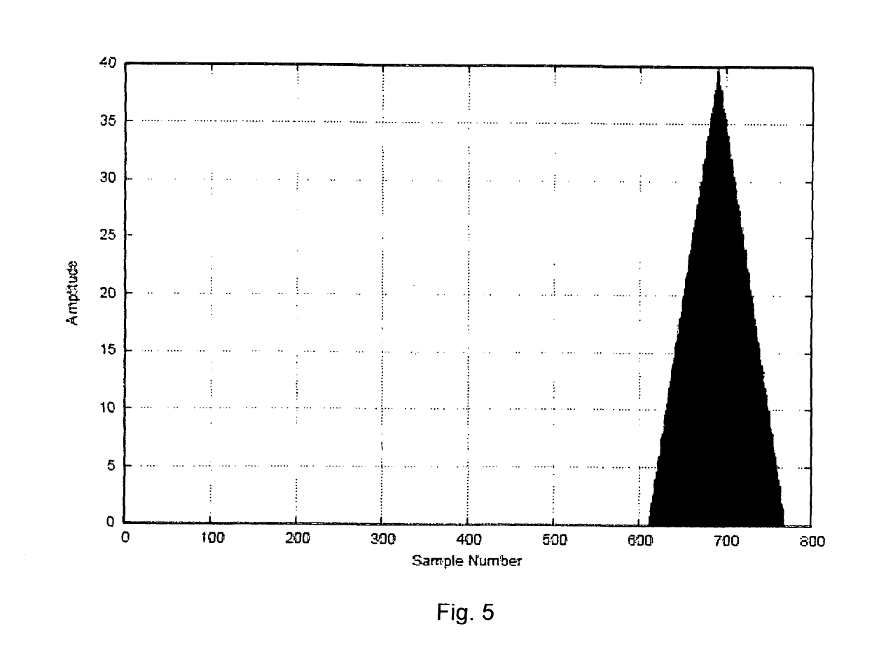

Consider FIG. 4a, in which a further received signal 300 is shown in addition to an erroneous initial portion 310. The initial portion 310 may be produced when producing the signal (e.g. as a result of the signal being built-up), or may be spurious noise (e.g. noise at the same frequency as the signal). Here, the initial portion 310 travels at the front of the signal 300. FIG. 4a further shows a final portion 320, which follows at the end of the signal 300.

FIG. 4b shows a similar exemplary signal 300. Here, the signal 300 has a frequency of 2 MHz and has a pulse length of 5 μs, which is 10 cycles. The signal 300 also has an initial portion 310 and a final portion 320 (e.g. produced by noise, or the like).

Here the sampling frequency provides an integer number of samples per cycle, such as by using a sampling frequency of 16 MHz, which would provide 80 samples over the entire pulse. When using Discrete Fourier Transform, the frequency resolution possible is a function of the sampling frequency and the number of samples taken. If only 80 samples were taken, then this would provide a frequency resolution of 0.2 MHz, which would mean that the signal 300 would be observed in bin 10. That is to say that we only need to consider this one frequency. This makes the analysis comparatively faster.

When receiving the received signal 300, samples are taken at regular intervals in a similar manner to that described above. In this case consider that 800 samples are taken in total, and that this is sufficient to capture the received signal 300. Consider again that from sample 0 to sample 689 no signal 300 is received, but at sample 690 the signal 300 has arrived.

It is possible to perform a DFT analysis of length 80 samples, which in this example starts at sample 0. That is to say, it is not necessary to provide a DFT analysis on 800 samples at the same time. On the contrary, it is possible to move along one sample and do the same analysis again. In other words, a DFT analysis is performed on samples sets 0 to 79, 1 to 80, 2 to 81, 3 to 83, etc.

At these early sample sets nothing is detected. In other words, the magnitude of the DFT output for this frequency would be 0. As the initial sample 690 is observed, we begin to draw in samples of the arrived signal. FIG. 5 shows the magnitude of the sliding DFT against sample number.

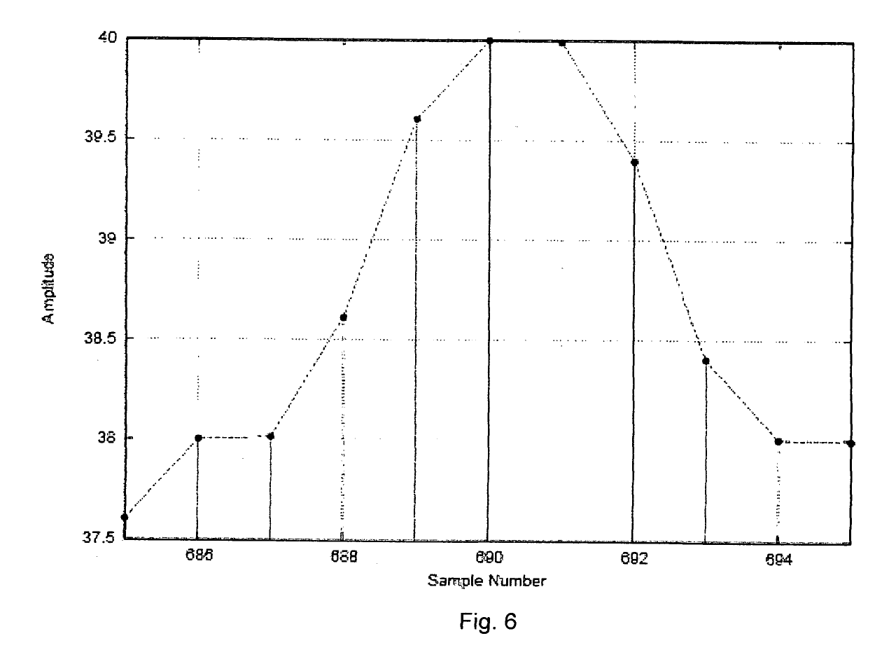

FIG. 6 is an enlarged view of FIG. 5 in the region of the initial sample 690. A maximum amplitude occurs at this point. For each DFT it is possible to provide the associated phase angle. Therefore, it is possible to observe that at sample 690 (samples start at 0) a received phase angle of 5.760011 degrees is present. Also, at that sample the magnitude is a maximum (39.999997).

Using Equation (1), it is possible to calculate the time of receipt of the signal as:

$$t = \frac{690}{16 MHz} - \frac{5.760011}{360 * 2 MHz} = 43.117 μs$$

Of course, had the sample before (689) been used, the time of receipt of the signal would be:

$$t = \frac{689}{16 MHz} - \frac{- 38.531165}{360 * 2 MHz} = 43.117 μs$$

The relative angle between these samples is changed by 45 degrees because of the frequency of the received signal and sampling frequency. Although it is detected that a received phase angle of 5.760011 degrees is observed at sample 690, when we slide along by one sample and perform a DFT starting at sample 691 a received phase angle of 50.760011 degrees is observed. Calculating the time of receipt of the signal 300 using this sample we get:

$$t = \frac{691}{16 MHz} - \frac{50.76001}{360 * 2 MHz} = 43.117 μs$$

Which is the same time of receipt even though we have advanced by one sample.

For this signal 300, 2 MHz sampled at 16 MHz, we have eight samples in a cycle. That is to say that we have a sample integer of eight. It is found that performing a sliding DFT of eight samples give the same time of receipt for that cycle. When we move on to the next cycle our time of receipt advance by 0.5 μs, which is the time for one cycle of a 2 MHz frequency.

In this way it is possible to compute a more accurate time of receipt for any frequency within the signal 300 to much better than one sample accuracy. In some cases, the accuracy is of a phase measurement to within 1 degree, which is 1/360 of the sampling frequency. In the example shown, the sampling frequency is 16 MHz, so the time between samples is 1/16000000 s=62.5 ns (nanoseconds). So ( 1/360)*62.6=0.174 ns. This can provide a considerable improvement in accuracy with no increase in sampling rates or processing.

It will readily be appreciated that the above example may be used when receiving signals having two or more frequency components, in a similar manner to that described in relation to FIG. 2c.

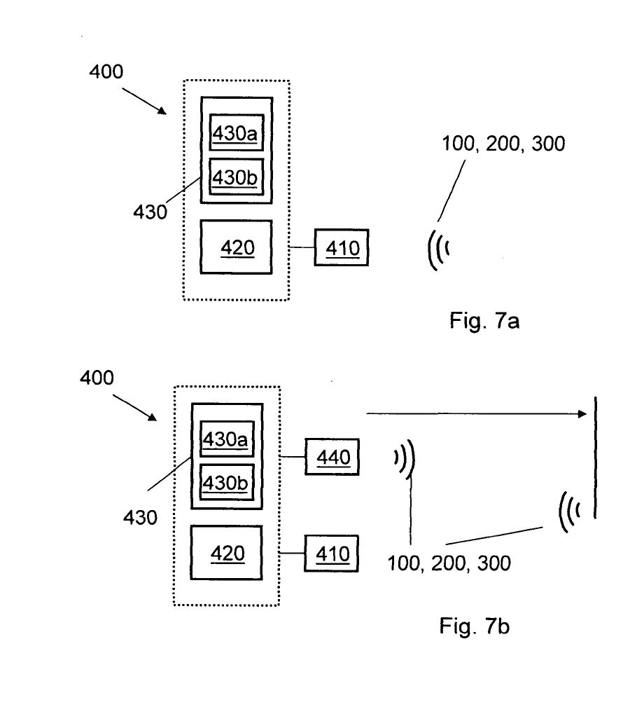

FIG. 7a shows exemplary apparatus 400 for use in implementing the above methods. The apparatus 400 comprises a receiver 410, an analogue to digital converter (ADC) 420, and a controller 430. The controller 430 comprises a processor 430a and memory 440b, configured in a known manner. The apparatus 400 is configured to receive a signal 100, 200, 300 and sample the signal 100, 200, 300 at a number of samples using the ADC 420. The phase characteristics at those samples (e.g. phase angle, amplitude, or the like) are then provided to the controller in order to determine the receive time error. This can then be used in order to determine the time of receipt of the signal, for example, by subtracting the receive time error from the receive time.

FIG. 7b shows another example of apparatus 400, but further comprising a transmitter 440. Here, the transmitter 440 is configured to transmit a signal 100, 200, 300 for subsequent receipt by the receiver 410. In this example, the apparatus 400 is configured such that the signal 100, 200, 300 is transmitted to an object, or target 500. The target 500 reflects the signal 100, 200, 300 back to the apparatus 400, which is received at the receiver 410.

The time of flight can be determined by subtracting the receive time error from the receive time. From the time of flight, the distance to the target 500 can be determined (e.g. by using an estimated, or approximated, or determined speed of the signal 100, 200, 300).

It will be appreciated to the skilled reader that the features of the apparatus (i.e. the ability to determine the receive time error) may be provided by the controller 430, configured such that it is able to carry out the desired operations only when enabled, e.g. switched on, or the like. In such cases, it may not necessarily have the appropriate software loaded into the active memory in the non-enabled state (e.g. switched off state) and only load the appropriate software in the enabled state (e.g. on state).

In addition, it will be appreciated that any of the aforementioned apparatus 400, may have other functions in addition to the mentioned functions, and that these functions may be performed by the same apparatus.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the invention may consist of any such individual feature or combination of features. In view of the foregoing description it will be evident to a person skilled in the art that various modifications may be made within the scope of the invention.

1. A method for providing for determining the time of receipt of a received signal, the method comprising:
using at least one processor to determine a receive time error by using a phase characteristic associated with a received phase angle at which a received signal is initially sampled together with the frequency of the received signal, the receive time error representative of the time taken for the received signal to travel between a reference phase angle and the received phase angle so as to provide for determining the time of receipt of the received signal.

2. A method according to claim 1, wherein the phase characteristic is the difference between the reference phase angle and the received phase angle.

3. A method according to claim 1, wherein the phase characteristic is derivable from the amplitude of the received signal at the received phase angle.

4. A method according to claim 1, wherein the phase characteristic is the ratio of the difference between the received phase angle and the reference phase angle, with the cycle of the received signal.

5. A method according to claim 1 in which the phase characteristic is multiplied with the frequency of the received signal so as to provide the receive time error.

6. A method according to claim 1 in which the reference phase angle is associated with an initial phase offset of a transmitted signal, the transmitted signal being for subsequent receipt as the received signal.

7. The method according to claim 1, comprising using two or more phase characteristics associated with the received phase angle in order to provide for determining the time of receipt of the signal.

8. The method according to claim 7, wherein the two or more phase characteristics are associated with two or more different temporally displaced samples.

9. The method according to claim 7, wherein the two or more phase characteristics are associated with two or more frequency components of the received signal.

10. The method according to claim 7, comprising comparing the two or more phase characteristics in order to provide the receive time error.

11. The method according to claim 7, comprising predicting the two or more phase characteristics in order to provide the receive time error.

12. The method according to claim 11 comprising predicting one or more phase characteristics based on at least one of a previously used and observed phase characteristic.

13. The method according to claim 11, wherein predicted phase characteristics are based on one or more of: the frequency of the received signal; the sampling frequency of the received signal; and the phase characteristic of one or more previous samples.

14. The method according to claim 1 further comprising sampling the received signal at a sampling frequency corresponding to the frequency of the received signal so as to provide an integer number of samples per cycle.

15. The method according to claim 14, comprising providing a signal amplitude at two or more samples of the received signal, the signal amplitude observed by discrete frequency transform, and using the phase characteristic associated with a particular sample associated with the largest amplitude to provide the receive time error.

16. The method according to claim 15, wherein the signal amplitude is provided for two or more sets of samples, each set of samples comprising a number of samples corresponding to the sample integer, the two or more sets of samples having one or more overlapping samples, and using the phase characteristics associated with a particular sample set associated with a largest signal amplitude to provide the receive time error.

17. The method according to claim 1 comprising at least one of receiving the received signal, and transmitting a signal for subsequent receipt as a received signal.

18. The method according to claim 1 comprising using the receive time error with a receive time of the signal in order to provide for determining the time of receipt of the signal.

19. The method according to claim 18, wherein the receive time relates to the time at which the received signal is initially sampled.

20. The method according to claim 19, wherein the receive time is provided by using a sample number of the initial sample, and the sampling frequency used to sample the received signal, wherein the sample number is the cumulative number of samples taken between a reference time and the initial sample.

21. (canceled)

22. The method according to claim 1 comprising determining, using at least one processor, the time of receipt of the signal, the time of receipt being determined to be the received time minus the receive time error.

23. The method according to claim 22, comprising using the time of receipt to determine time of flight of the received signal.

24. The method according to claim 23, comprising using the speed of the signal and time of receipt in order to determine the distance travelled by the received signal.

25. The method according to claim 1, wherein the received signal comprises an acoustic signal for use in a flowmeter.

26. Apparatus for providing for determining the time of receipt of a received signal, the apparatus comprising at least one processor configured to use a phase characteristic associated with a received phase angle at which a received signal is initially sampled together with the frequency of the received signal to determine a receive time error, the receive time error representative of the time taken for the received signal to travel between a reference phase angle and the received phase angle, the apparatus configured to provide for determining the time of receipt of the received signal.

27. A measurement device, such as an oil and gas measurement device, comprising the apparatus of claim 26.

28. (canceled)

29. A computer program product stored on a computer readable medium, the computer program product configured to provide the method of claim 1.

30.-31. (canceled)
